(19) United States
(12) Patent Application Publication
(10) Pub. No.: US 2020/0232775 A1
(43) Pub. Date: Jul. 23, 2020

(54) WIRE GAUGE TOOLS

(71) Applicant: John James Komarinski, Greensburg, PA (US)

(72) Inventor: John James Komarinski, Greensburg, PA (US)

(21) Appl. No.: 16/749,043

(22) Filed: Jan. 22, 2020

Related U.S. Application Data
(60) Provisional application No. 62/795,209, filed on Jan. 22, 2019.

(51) Int. Cl. G01B 3/04; G01B 3/34; G01B 5/08; H02G 3/04

(52) U.S. Cl. CPC G01B 3/04; G01B 3/34; H02G 2200/20; H02G 3/0481; G01B 5/08

(57) ABSTRACT

A kit of wire gauge tools is provided. Each wire gauge tool is dimensioned and adapted to measure a diameter of wiring and associated insulation. Each wire gauge tool may be elongated with a thin profile, where both ends provide a different measuring slot. The present invention may include a case for housing the kit or plurality of wire gauge tools. Each wire gauge tool in the kit may be a different color for immediate identification of the diameters measurable with that specific tool.

### CROSS-REFERENCE TO RELATED APPLICATION

This application claims the benefit of priority of U.S. provisional application No. 62/795,209, filed 22 Jan. 2019, the contents of which are herein incorporated by reference.

### BACKGROUND OF THE INVENTION

The present invention relates to wire gauge tools and, more particularly, to a kit providing a plurality of measuring guide tools for measuring ‘installed’ electrical wire diameters, for example wherein the electrical wire still has insulation intact.

Electricians, tradesmen specializing in electrical wiring, handymen, and do-it-yourselfers who install new electrical components or provide maintenance for or repair existing electrical components all face the challenge of reading or acquiring the correct wire sizes in electrical panels, enclosures or other restricted areas. Specifically, when there are no marked or legible size markings on the wires as these wires would need to be removed in order to measure the actual copper. Guessing the size happens frequently though not recommended as it will alter arc fault and arc flash calculations, among other work that is precision-based.

Typical wire gauges are made of metal and often wheel shaped which can make them difficult and unsafe for use in electrical enclosures. Likewise, in an electrical enclosure, round metal gauges are also a safety risk.

As can be seen, there is a need for a kit providing a plurality of measuring guide tools for measuring the diameters of ‘installed’ electrical wire, which are frequently unmarked or have diameter markers that are illegible. Each guide tool has slots on each end of a flat non-conductive blade. Each slot is dimensioned to snugly receive only one specified diameter of wire including the thickness of the insulation. The non-conductive blade is shaped to reach deep enough to measure wires at the breaker if needed. The present invention is the only wire measuring tool that measures the insulation and not the wire itself, thus eliminating the need to disconnect wires prior to measuring them when determining correct wire sizes.

### SUMMARY OF THE INVENTION

In one aspect of the present invention, a kit of wire gauge tools provides a plurality of wire gauge tools, each gauge tool having the following: an elongated body portion having a length at least three times a width; a thickness of the elongated body portion being at least one-fourth said width; and a gauge slot on each end of the elongated body portion, the gauge slot defining a U-shape void in the elongated body portion, wherein a diameter of a curve portion of said U-shape void matches a measurement indicium provided on the elongated body portion adjacent the said U-shape void.

In another aspect of the present invention, the kit of wire gauge tools, provides the following: a plurality of wire gauge tools, each wire gauge tool includes the following: an elongated body portion having a length at least three times a width; a thickness of the elongated body portion being at least one-fourth said width; a gauge slot on each end of the elongated body portion, the gauge slot defining a U-shape void in the elongated body portion, wherein a diameter of a curve portion of said U-shape void matches a measurement indicium provided on the elongated body portion adjacent the said U-shape void, wherein the diameter of each curve portion is different from the other curve portions of the plurality of wire gauge tools wherein each wire gauge tool is a color different from other wire gauge tools of the plurality thereof; and a case for retrievably housing the plurality of wire gauge tools.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, illustrating an array or plurality of wire gauges tools 10;

FIG. 2 is a perspective view of an exemplary embodiment of the present invention, shown in use;

FIG. 3 is a perspective view of an exemplary embodiment of the present invention, illustrating a set of wire gauges tools 10;

FIG. 4 is a section view of an exemplary embodiment of the present invention, taken along line 4-4 of FIG. 3; and

FIG. 5 is a front view of an exemplary embodiment of a nine-piece set of wire gauges tools 10 of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a kit of wire gauge tools dimensioned and adapted to measure the diameter of wiring and associated insulation. Each wire gauge tool may be elongated with a thin profile, where both ends provide a different measuring slot. The present invention may include a case for housing the kit or plurality of wire gauge tools.

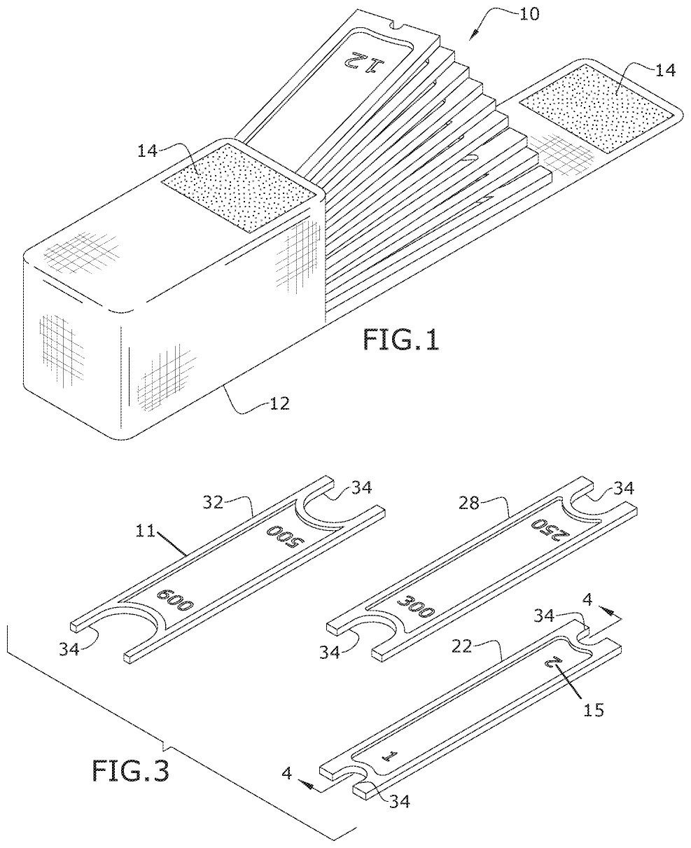

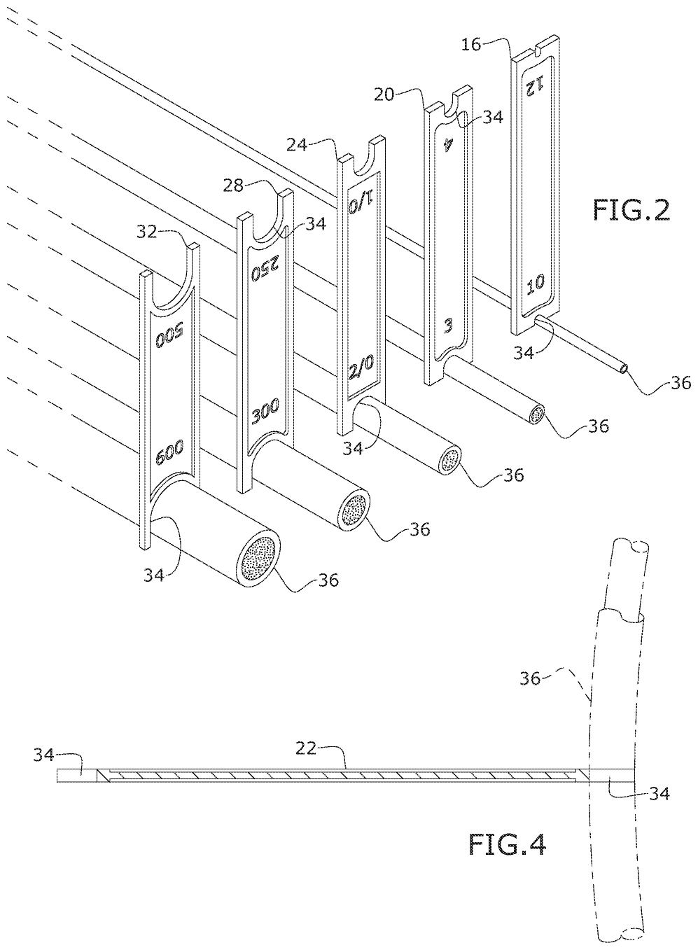

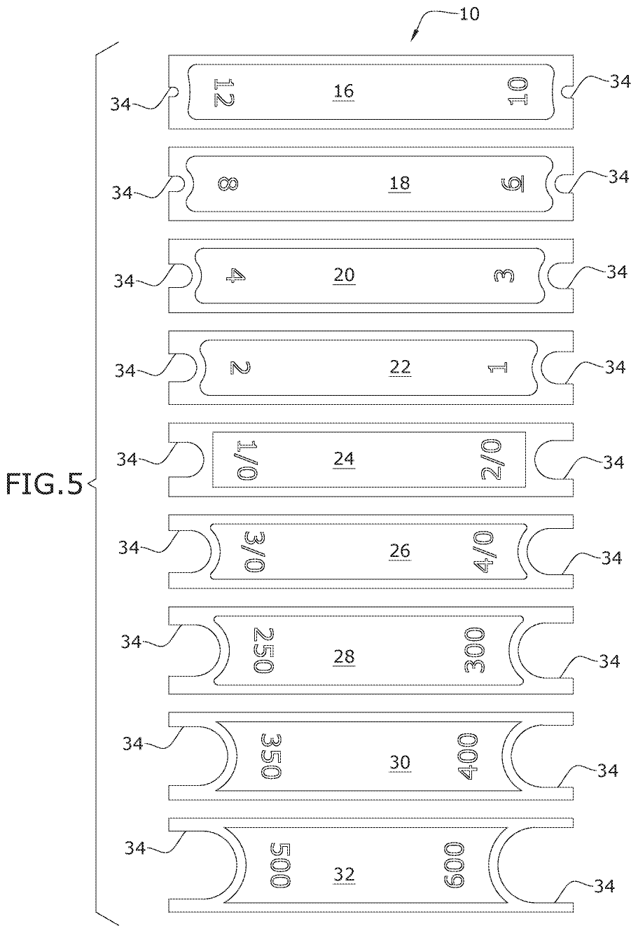

Referring to FIGS. 1 through 5, the present invention may include a set or plurality of wire gauge tools 10 for determining the gauge sizes of insulated, installed wiring 36. Each wire gauge tool 10 provides an elongated body portion 11. Each body portion 11 may be generally planar and made of non-conductive material, such as plastic or the like. Each end of each body portion 11 may provide a gauge slot 34. Adjacent each gauge slot 34 may be a measurement indicium 15 of the adjacent slots measuring diameter.

Each gauge slot 34 may be generally U-shaped with the curved portion of the U-shape extending toward a middle of the body portion 11. The curved portion may be a function of a predetermined diameter that the associated wire gauge tool 10 is measuring for. It should be understood that each wire gauge tool 10 may have different diameter gauge slots 34 on each end, or the same on each end. For example, there may be a wire gauge tool 10 for a 10,12 gauge 16.

It should be understood that the numbers ‘10’ and ‘12’ in the “10,12 gauge” term refers to the American wire gauge (AWG) standardized wire gauge system for the diameters of round, solid, nonferrous, electrically conducting wire. These AWG sizes are reflected in the associated, adjacent measurement indicium 15. The 10,12 gauge 16, thus has a ‘10’ AWG size (0.100 inch diameter) gauge slot 34 on one end and a ‘12’ AWG size (0.0791 inch diameter) gauge slot 34 on the other end. A plurality or set of wire gauge tools 10 may also include a 6, 8 gauge, a 3,4 gauge 20, a 1, 2 gauge 22, a 1/0, 2/0 gauge 24, a 3/0, 4/0 gauge 26, a 250/300 gauge 28, a 350/400 gauge 30, a 500/600 gauge 32, and the like. Together, these gauges may define a set or plurality of wire gauge tools 10.

The elongated, planar body portion 11 is a shape that enables ease of use in the field as users commonly have to navigate through other wiring and equipment to operatively engaged the desired wiring. The planar body portion 11 may resemble a six-inch ruler, though the length of the body portion may extend between four to eight or more inches.

In certain embodiments, a case 12 dimensioned and adapted to retrievably house the plurality of gauge tools 10 in kit form. The case 12 may have a lid with a removably fastener 14 for moving the lid between an open condition, as illustrated in FIG. 1 and a securely closed condition.

A method of manufacturing the present invention may include the following. A manufacturer may first determine the diameter of wire conductors including the insulation. There are slight variances in wire insulation diameters among the different manufactures, and so the manufacturer needs to pick a tool size that will determine the correct size while working with these known variances. This requires the manufacture to engage in trial tests and tweaking to determine the finished production sizes of gauge slots 34 to be formed. Once that measurements are defined, the manufacturer would need a three-dimensional 3D format drawing for use in production. For each individual wire measuring tool 10, a 3D drawing will be produced. Production can be provided through additive manufacture, 3D-printing, computer numerical control (CNC) machining, injection molding, or the like. Each wire gauge tool 10 may be a different color so different colors of filament are used in production. The reason for the different colors is for ease of tool selection, as color is more readily identifiable in comparison to reading the printed size/AWG measurement indicium 15 on each tool. Although 3D printing is very accurate to size, testing is done using samples of wires 36 from various manufacturers. On occasion drawings might be changed and tools reprinted with updates.

A method of using the present invention may include the following. The set or plurality of wire gauges tools 10 disclosed above may be provided. When performing an electrical ARC Flash assessment or “As Built” electrical drawing, wire conductor sizes need to be verified. It is usually difficult to read, or even see the small writing on the installed wires. Sometimes there isn't labeling on the wire at all. Simply by placing the wire gauges tool 10 over the insulated wire so that the wire 36 fits or does not fit snugly in the gauge slot 34 at the end of the wire gauges tool 10. The next smaller will not fit at all within the gauge slot 34, while the next larger wire/conduit 36 will be loose and sloppy, i.e., not snug, making it easy to pick the correct size.

Thereby, the diameter of the wiring including the insulation will be identified when the wire fits snug in the slot. The present invention saves time and eliminates mistakes and guesswork when visible wire size labels are gone or not legible, as placing the wire gauges tool 10 over the insulated wire 36 the correct wire size will fit snug in the slot.

It should be understood, of course, that the foregoing relates to exemplary embodiments of the invention and that modifications may be made without departing from the spirit and scope of the invention as set forth in the following claims.

What is claimed is:

1. A kit of wire gauge tools, comprising:
a plurality of wire gauge tools, each wire gauge tool comprising:
an elongated body portion having a length at least three times a width;
a thickness of the elongated body portion being at least one-fourth said width; and
a gauge slot on each end of the elongated body portion, the gauge slot defining a U-shape void in the elongated body portion, wherein a diameter of a curve portion of said U-shape void matches a measurement indicium provided on the elongated body portion adjacent the said U-shape void.

2. The kit of wire gauge tools of claim 1, wherein each wire gauge tool is a color different from other wire gauge tools of the plurality thereof.

3. The kit of wire gauge tools of claim 1, wherein the diameter of each curve portion is different from the other curve portions of the plurality of wire gauge tools.

4. The kit of wire gauge tools of claim 1, further comprising a case for retrievably housing the plurality of wire gauge tools.

5. A method of measuring a diameter of an installed wire including insulation thereof, comprising:
providing the kit of wire gauge tools of claim 1; and
urging one of the gauge slots so as to slidably receive said installed wire snugly therein.

6. A kit of wire gauge tools, comprising:
a plurality of wire gauge tools, each wire gauge tool comprising:
an elongated body portion having a length at least three times a width;
a thickness of the elongated body portion being at least one-fourth said width;
a gauge slot on each end of the elongated body portion, the gauge slot defining a U-shape void in the elongated body portion, wherein a diameter of a curve portion of said U-shape void matches a measurement indicium provided on the elongated body portion adjacent the said U-shape void, wherein the diameter of each curve portion is different from the other curve portions of the plurality of wire gauge tools wherein each wire gauge tool is a color different from other wire gauge tools of the plurality thereof; and
a case for retrievably housing the plurality of wire gauge tools.
